(19) United States
(12) Patent Application Publication
(10) Pub. No.: US 2021/0326487 A1
(43) Pub. Date: Oct. 21, 2021

(54) LOCKING METHOD AND RELATED ELECTRONIC DEVICE

(71) Applicant: HUAWEI TECHNOLOGIES CO., LTD., SHENZHEN (CN)

(72) Inventors: Zhensheng ZHOU, Dongguan (CN); Zengcai SUN, Wuhan (CN); Yi LI, Shenzhen (CN); Fengjun LI, Hangzhou (CN); Jingdong WU, Shenzhen (CN)

(21) Appl. No.: 17/360,274

(22) Filed: Jun. 28, 2021

Related U.S. Application Data
(63) Continuation of application No. PCT/CN2019/129639, filed on Dec. 28, 2019.

(30) Foreign Application Priority Data
Dec. 29, 2018 (CN) 201811654921.4

(51) Int. Cl. G06F 21/70; G06F 21/31

(52) U.S. Cl. CPC G06F 21/70; G06F 21/31

(57) ABSTRACT

A locking method and a related device are provided. The method is applied to an electronic device, where the electronic device includes a processor and a locking control circuit, and the locking control circuit is capable of running when the electronic device is in a power-off state or a power-on state. The method includes: modifying, by the locking control circuit, a state flag to a first state flag when the electronic device needs to be locked, where the first state flag is used to indicate a state that the electronic device needs to be locked and is not locked; controlling, by the locking control circuit, the electronic device to restart; reading, by the processor, the state flag in a startup phase of the electronic device restart; and locking the electronic device when the processor determines that the state flag is the first state flag.

### CROSS-REFERENCE TO RELATED APPLICATIONS

This application is a continuation of International Application No. PCT/CN2019/129639, filed on Dec. 28, 2019, which claims priority to Chinese Patent Application No. 201811654921.4, filed on Dec. 29, 2018. The disclosures of the aforementioned applications are hereby incorporated by reference in their entireties.

### TECHNICAL FIELD

This application relates to the field of computer technologies, and in particular, to a locking method and a related electronic device.

### BACKGROUND

Currently, to prevent a lost electronic device such as a computer, and a mobile phone from being embezzled by others or leading to information leakage, a locking function is generally set in the electronic device. In current practical applications, after finding that his/her electronic device is lost, a user can log in to an electronic device management platform. After a user identity is authenticated by the electronic device management platform, the electronic device management platform sends a locking instruction to the electronic device, and the electronic device performs a locking operation after receiving the locking instruction sent from the electronic device management platform. However, in the prior art, locking of an electronic device depends on an operating system of the electronic device. If the thief performs a flashing operation after shutting down the lost electronic device, the electronic device cannot complete locking successfully, causing property loss to the user and user information leakage. How to safely lock an electronic device has become an urgent issue to be resolved by those skilled in the art.

### SUMMARY

Embodiments of this application provide a locking method and a related electronic device, to safely lock an electronic device.

According to a first aspect, this application provides a locking method. The method is applied to an electronic device, where the electronic device includes a processor and a locking control circuit, and the locking control circuit is capable of running when the electronic device is in a power-off state or a power-on state. The method includes: modifying, by the locking control circuit, a state flag to a first state flag when the electronic device needs to be locked, where the state flag is used to indicate a state of the electronic device, and the state includes whether the electronic device needs to be locked and whether the electronic device has already been locked; and the first state flag is used to indicate a state that the electronic device needs to be locked and is not locked; controlling, by the locking control circuit, the electronic device to restart; reading, by the processor, the state flag in a startup phase of the electronic device restart; and locking, by the processor, the electronic device when the processor determines that the state flag is the first state flag.

In the foregoing method, the locking control circuit modifies the state flag to the first state flag when the electronic device needs to be locked, and then controls the electronic device to restart; and the processor determines, based on the read first state flag in the startup phase of the electronic device, that the device needs to be locked and is not locked, and then performs a locking operation on the electronic device. Because the locking control circuit is capable of running when the electronic device is in a power-off state or a power-on state, locking of the electronic device does not depend on an operating system of the electronic device, so that the electronic device can be securely locked.

In one embodiment, the state flag is stored in a secure element or the locking control circuit. In this manner, a thief is unable to change a locked state of the electronic device by damaging an operating system of the electronic device, improving security of the electronic device.

In one embodiment, the startup phase is before startup of an operating system of the electronic device. In this manner, a thief is unable to unlock the electronic device by damaging the operating system of the electronic device, improving security of the electronic device.

In one embodiment, if the electronic device is a computer, the startup phase is a basic input/output system BIOS startup phase; and if the electronic device is a mobile phone, the startup phase is a bootloader phase.

In one embodiment, the state flag is stored in the locking control circuit, and the reading, by the processor, the state flag in a startup phase of the electronic device restart includes: sending, by the processor, indication information to the locking control circuit, where the indication information is used to instruct the locking control circuit to send the state flag to the processor; performing, by the locking control circuit, security authentication on the processor; and sending, by the locking control circuit, the state flag to the processor if the security authentication succeeds. In this manner, the state flag is stored, read, and modified by the locking control circuit, and security authentication on the processor is added in the reading process. This can prevent the state flag from being parsed or modified maliciously, improving locking safety.

In one embodiment, the modifying, by the locking control circuit, a state flag to a first state flag when the electronic device needs to be locked includes: receiving, by the processor, a locking instruction from a server through a first application; and notifying, by the processor according to the locking instruction, the locking control circuit to modify the state flag to the first state flag.

In one embodiment, the electronic device includes a low power communication circuit, and the modifying, by the locking control circuit, a state flag to a first state flag when the electronic device needs to be locked includes: receiving, by the locking control circuit, a locking instruction from a server through the low power communication circuit; and modifying, by the locking control circuit, the state flag to the first state flag. In this manner, when the electronic device is in a power-off state or an offline state, the locking instruction sent from the server can be received through the low power communication circuit, avoiding a problem that the electronic device fails to receive the locking instruction in a power-off state or an offline state. Moreover, with a characteristic of low power consumption, the low power communication circuit does not consume too much power of the electronic device or affect normal use of the electronic device.

In one embodiment, the modifying, by the locking control circuit, a state flag to a first state flag when the electronic device needs to be locked includes: modifying, by the locking control circuit, the state flag to the first state flag when it is detected that the electronic device is being disassembled. In this manner, the electronic device can be locked when a thief is disassembling the electronic device maliciously, preventing a locking failure due to disassembling of the locking control circuit by the thief, and improving security of the electronic device.

In one embodiment, the modifying, by the locking control circuit, a state flag to a first state flag when the electronic device needs to be locked includes: modifying, by the locking control circuit, the state flag to the first state flag when it is detected that a power level of the electronic device falls below a first preset value. In this manner, a problem can be avoided that the electronic device fails to be restarted and locked after a thief uses up power of the electronic device maliciously, improving security of the electronic device.

In one embodiment, the electronic device includes a low power communication circuit, and the method further includes: checking, by the low power communication circuit, whether the low power communication circuit is normally connected to a server according to a preset cycle, where the modifying, by the locking control circuit, a state flag to a first state flag when the electronic device needs to be locked includes: modifying, by the locking control circuit, the state flag to the first state flag when detecting that the electronic device fails to connect to the server within a preset time period through the low power communication circuit. In this manner, a problem can be avoided that the electronic device fails to receive the locking instruction after a thief masks a signal from the low power communication circuit of the electronic device, improving security of the electronic device.

In one embodiment, the locking the electronic device includes: generating, by the processor, a locking password; using, by the processor, the locking password to lock the electronic device; and sending, by the processor, the locking password to the server.

In one embodiment, the locking the electronic device includes: sending, by the processor, indication information to the server, where the indication information is used to instruct the server to generate a locking password; and receiving, by the processor, the locking password from the server and using the locking password to lock the electronic device.

In one embodiment, the locking the electronic device includes: generating, by the processor, a first locking password; sending, by the processor, indication information to a server, where the indication information is used to instruct the server to generate a second locking password; receiving, by the processor, the second locking password from the server; using, by the processor, the first locking password and the second locking password to lock the electronic device; and sending, by the processor, the first locking password to the server. In this manner, the locking passwords of the electronic device are generated by the electronic device and the server jointly, improving password security.

In one embodiment, the electronic device includes a hard disk, and the locking the electronic device includes: locking a main board of the electronic device, and locking the hard disk, where the locking password includes a main board locking password and a hard disk locking password, the main board locking password is used to lock the main board, the hard disk locking password is used to lock the hard disk, and the hard disk locking password is stored in the hard disk.

In one embodiment, the method further includes: after the locking is complete, modifying, by the locking control circuit, the state flag to a second state flag, where the second state flag is used to indicate a state that the electronic device needs to be locked and is already locked.

In one embodiment, the method further includes: when the processor determines in the startup phase that the state flag is the second state flag, pausing, by the processor, the startup, requesting user identity authentication, and continuing the startup after a user identity is authenticated.

In one embodiment, the electronic device includes the low power communication circuit, and the method further includes: after the locking is complete, controlling, by the locking control circuit, the electronic device to power off, and sending a locking complete message to the server through the low power communication circuit.

In one embodiment, the method further includes: receiving, by the processor, an unlocking credential sent from the server, where the unlocking credential is generated based on the locking password after the user identity authentication succeeds; matching, by the processor, the unlocking credential with the locking password; and if the match succeeds, clearing, by the processor, the locking password to complete the unlocking.

In one embodiment, the method further includes: modifying, by the locking control circuit, the state flag to a third state flag after the electronic device is unlocked, where the third state flag is used to indicate a state that the electronic device does not need to be locked; and starting, by the processor, the electronic device normally.

In one embodiment, the locking control circuit is one or more of an embedded controller EC, a microcontroller MCU, a digital signal processor, and a power management integrated circuit PMIC.

In one embodiment, the low power communication circuit is one or more of a narrow band internet of things NB-IoT circuit, an enhanced machine type communication eMTC circuit, a long range radio LoRa circuit, a Sigfox circuit, a bluetooth low energy BLE circuit, a low power WIFI circuit, and a massive machine type communication mMTC circuit.

According to a second aspect, this application provides an electronic device, where the electronic device includes a processor and a locking control circuit, and the locking control circuit is capable of running when the electronic device is in a power-off state or a power-on state. The locking control circuit is configured to perform the following operations: modifying a state flag to a first state flag when the electronic device needs to be locked, where the state flag is used to indicate a state of the electronic device, the state includes whether the electronic device needs to be locked and whether the electronic device has already been locked, and the first state flag is used to indicate a state that the electronic device needs to be locked and is not locked; and controlling the electronic device to restart. The processor is configured to perform the following operations: reading the state flag in a startup phase of the electronic device restart; and locking the electronic device when the state flag is the first state flag.

In the foregoing electronic device, the locking control circuit modifies the state flag to the first state flag when the electronic device needs to be locked, and then controls the electronic device to restart; and in the startup phase of the electronic device, the processor determines, based on the read first state flag, that the device needs to be locked and is not locked, and then performs a locking operation on the electronic device. Because the locking control circuit is capable of running when the electronic device is in a power-off state or a power-on state, locking of the electronic device does not depend on an operating system of the electronic device, so that secure locking can be performed.

In one embodiment, the state flag is stored in a secure element or the locking control circuit. In this manner, a thief is unable to change a locked state of the electronic device by damaging an operating system of the electronic device, improving security of the electronic device.

In one embodiment, the startup phase is before startup of an operating system of the electronic device. In this manner, a thief is unable to unlock the electronic device by damaging the operating system of the electronic device, improving security of the electronic device.

In one embodiment, if the electronic device is a computer, the startup phase is a basic input/output system BIOS startup phase; and if the electronic device is a mobile phone, the startup phase is a bootloader phase.

In one embodiment, the state flag is stored in the locking control circuit, and the processor is further configured to send indication information to the locking control circuit, where the indication information is used to instruct the locking control circuit to send the state flag to the processor; and the locking control circuit is further configured to: perform security authentication on the processor; and send the state flag to the processor when the security authentication succeeds. In this manner, the state flag is stored, read, and modified by the locking control circuit, and security authentication on the processor is added in the reading process, which can prevent the state flag from being parsed or modified maliciously, and improve locking security.

In one embodiment, the processor is further configured to: receive a locking instruction from a server through a first application; and notify, according to the locking instruction, the locking control circuit to modify the state flag to the first state flag.

In one embodiment, the electronic device includes a low power communication circuit, and the locking control circuit is further configured to: receive a locking instruction from a server through the low power communication circuit; and modify the state flag to the first state flag. In this manner, when the electronic device is in a power-off state or an offline state, the locking instruction sent from the server can be received through the low power communication circuit, avoiding a problem that the electronic device fails to receive the locking instruction in a power-off state or an offline state. Moreover, with a characteristic of low power consumption, the low power communication circuit does not consume too much power of the electronic device or affect normal use of the electronic device.

In one embodiment, the locking control circuit is further configured to modify the state flag to the first state flag when it is detected that the electronic device is being disassembled. In this manner, the electronic device can be locked when a thief is disassembling the electronic device maliciously, preventing a locking failure due to disassembling of the locking control circuit by the thief, and improving security of the electronic device.

In one embodiment, the locking control circuit is further configured to: modify the state flag to the first state flag when it is detected that a power level of the electronic device falls below a first preset value. In this manner, a problem can be avoided that the electronic device fails to be restarted and locked after a thief uses up power of the electronic device maliciously, improving security of the electronic device.

In one embodiment, the electronic device includes a low power communication circuit. The low power communication circuit is configured to check, according to a preset cycle, whether the low power communication circuit is normally connected to a server; and the locking control circuit is further configured to: modify the state flag to the first state flag when it is detected that the electronic device fails to connect to the server within a preset time period through the low power communication circuit. In this manner, a problem can be avoided that the electronic device fails to receive the locking instruction after a thief masks a signal from the low power communication circuit of the electronic device, improving security of the electronic device.

In one embodiment, the processor is specifically configured to: generate a locking password; use the locking password to lock the electronic device; and send the locking password to the server.

In one embodiment, the processor is specifically configured to: send indication information to the server, where the indication information is used to instruct the server to generate a locking password; and receive the locking password from the server, and use the locking password to lock the electronic device.

In one embodiment, the processor is specifically configured to generate a first locking password; send indication information to the server, where the indication information is used to instruct the server to generate a second locking password; receive the second locking password from the server; use the first locking password and the second locking password to lock the electronic device; and send the first locking password to the server. In this manner, the locking passwords of the electronic device are generated by the electronic device and the server jointly, improving password security.

In one embodiment, the electronic device includes a hard disk, and the processor is further configured to: lock a main board of the electronic device, and lock the hard disk, where the locking password includes a main board locking password and a hard disk locking password, the main board locking password is used to lock the main board, the hard disk locking password is used to lock the hard disk, and the hard disk locking password is stored in the hard disk.

In one embodiment, the locking control circuit is further configured to: after the locking is complete, modify the state flag to a second state flag, where the second state flag is used to indicate a state that the electronic device needs to be locked and is already locked.

In one embodiment, the processor is further configured to: when it is determined in the startup phase that the state flag is the second state flag, pause the startup, request user identity authentication, and continue the startup after a user identity is authenticated.

In one embodiment, the electronic device includes the low power communication circuit, and the locking control circuit is further configured to: after the locking is complete, control the electronic device to power off, and send a locking complete message to the server through the low power communication circuit.

In one embodiment, the processor is further configured to: receive an unlocking credential sent from the server, where the unlocking credential is generated based on the locking password after the user identity authentication succeeds; match the unlocking credential with the locking password; and if the match succeeds, clear the locking password to complete unlocking.

In one embodiment, the locking control circuit is further configured to: modify the state flag to a third state flag after the electronic device completes the unlocking, where the third state flag is used to indicate a state that the electronic device does not need to be locked; and the processor is further configured to start the electronic device normally.

In one embodiment, the locking control circuit is one or more of an embedded controller EC, a microcontroller MCU, a digital signal processor, and a power management integrated circuit PMIC.

In one embodiment, the low power communication circuit is one or more of a narrow band internet of things NB-IoT circuit, an enhanced machine type communication eMTC circuit, a long range radio LoRa circuit, a Sigfox circuit, a bluetooth low energy BLE circuit, a low power WIFI circuit, and a massive machine type communication mMTC circuit.

According to a third aspect, this application provides a locking control circuit, where the locking control circuit is applied in an electronic device, and the locking control circuit is capable of running when the electronic device is in a power-off state or a power-on state; and the locking control circuit is configured to perform the following operations: modifying a state flag to a first state flag when the electronic device needs to be locked, where the state flag is used to indicate a state of the electronic device, and the state includes whether the electronic device needs to be locked and whether the electronic device has already been locked; and the first state flag is used to indicate a state that the electronic device needs to be locked and is not locked, and in the startup phase of the electronic device, the first state flag is used to instruct a processor of the electronic device to lock the electronic device; and controlling the electronic device to restart.

In one embodiment, the locking control circuit is further configured to perform operations performed by the locking control circuit according to any one of the second aspect or the possible implementations of the second aspect.

According to a fourth aspect, this application provides a processor, applied in an electronic device. The processor is configured to perform the following operations: in a startup phase of the electronic device restart, reading a state flag set by a locking control circuit of the electronic device, where the locking control circuit is capable of running when the electronic device is in a power-off state or a power-on state, the state flag is used to indicate a state of the electronic device, and the state includes whether the electronic device needs to be locked and whether the electronic device has already been locked; and locking the electronic device when the processor determines that the state flag is a first state flag, where the first state flag is used to indicate a state that the electronic device needs to be locked and is not locked.

In one embodiment, the processor is further configured to perform operations performed by the processor according to any one of the second aspect or the possible implementations of the second aspect.

According to a fifth aspect, this application provides a computer-readable storage medium, where the computer-readable storage medium stores a program instruction, and when being executed by a processor, the program instruction causes the processor to perform the method according to any one of the first aspect or the possible implementations of the first aspect.

According to a sixth aspect, this application provides a computer program, where when running on a processor, the computer program causes the processor to perform the method according to any one of the first aspect or the possible implementations of the first aspect.

In the embodiments of this application, the locking control circuit modifies the state flag to the first state flag when the electronic device needs to be locked, and then controls the electronic device to restart; and in the startup phase of the electronic device, the processor determines, based on the read first state flag, that the device needs to be locked and is not locked, and then performs a locking operation on the electronic device. Because the locking control circuit is capable of running when the electronic device is in a power-off state or a power-on state, locking of the electronic device does not depend on an operating system of the electronic device, so that the electronic device can be securely locked.

### BRIEF DESCRIPTION OF DRAWINGS

To describe the technical solutions in the embodiments of this application or in the prior art more clearly, the following briefly describes the accompanying drawings for describing the embodiments or the prior art.

FIG. 1 is a schematic diagram of a locking system architecture according to an embodiment of this application;

FIG. 2 is a schematic architectural diagram of an electronic device according to an embodiment of this application;

FIG. 3 is a flowchart of a locking method according to an embodiment of this application;

FIG. 4 is a schematic diagram of a scenario in which locking is triggered according to an embodiment of this application;

FIG. 5 is a schematic diagram of another scenario in which locking is triggered according to an embodiment of this application;

FIG. 6 is a schematic diagram of another scenario in which locking is triggered according to an embodiment of this application;

FIG. 7 is a schematic diagram of another scenario in which locking is triggered according to an embodiment of this application;

FIG. 8 is a schematic diagram of another scenario in which locking is triggered according to an embodiment of this application;

FIG. 9 is a flowchart of an unlocking method according to an embodiment of this application; and

FIG. 10 is a schematic diagram of another electronic device according to an embodiment of this application.

### DESCRIPTION OF EMBODIMENTS

The following describes technical solutions in the embodiments of this application in more detail.

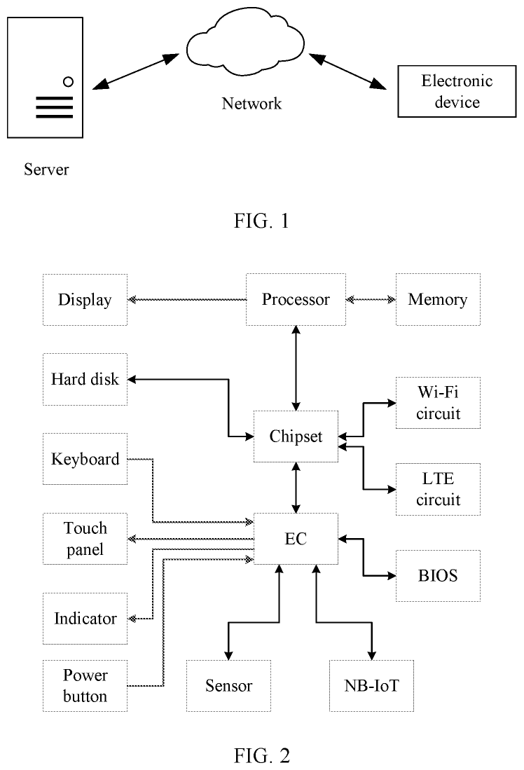

FIG. 1 is a schematic diagram of a locking system architecture according to an embodiment of this application. The system includes an electronic device and a server, and the electronic device can communicate with the server through a network. The following specifically describes the foregoing electronic device.

The electronic device is an electronic device that can provide a variety of application functions for a user, such as a mobile phone, a tablet computer, and a notebook computer. The electronic device can communicate with a server through a mobile communications technology, for example, a second generation mobile communications technology (2G), a third generation mobile communications technology (3G), a fourth generation mobile communications technology (4G), or a fifth generation mobile communications technology (5G), and can also communicate with the server through a wireless local area network (WLAN). Specifically, the electronic device includes a locking control circuit, and the locking control circuit is capable of running when the electronic device is in a power-off state or a power-on state.

The server is a server that is configured to lock and unlock an electronic device. After user identity authentication succeeds, the server can perform a locking operation on an electronic device, or can perform an unlocking operation on a locked electronic device.

FIG. 2 is a schematic structural diagram of an electronic device according to an embodiment of this application. The following describes components of the electronic device shown in the figure. As shown in FIG. 2, the electronic device includes a processor, an EC, a BIOS, an NB-IoT, a display, a memory, a hard disk, a chipset, a Wi-Fi circuit, an LTE circuit, a keyboard, a touch panel, an indicator, a power button, and a sensor. A person skilled in the art can understand that the electronic device shown in FIG. 2 is merely an example according to an embodiment of the present application, a structure of the electronic device shown in FIG. 2 constitutes no limitation on the electronic device, and the electronic device may include components more or fewer than those shown in the figure, combine some components, or split some components, or arrange the components differently.

The processor (CPU) is a very large scale integrated circuit, and is the computing core and control core (control unit) of the electronic device. The processor can parse a program instruction, process data, and perform operations. In this embodiment of this application, the processor can read a state flag in a startup phase of the electronic device restart; and lock the electronic device when determining that the state flag is a first state flag. In one embodiment, after user identity authentication succeeds, the processor may further complete an unlocking operation on the electronic device.

The embedded controller (EC) is a locking control circuit in this application. The locking control circuit in this application may alternatively be a micro controller (MCU), a digital signal processor, a power management integrated circuit (PMIC), or the like. In FIG. 2, an example in which the locking control circuit is an EC is used. The EC is capable of running when the electronic device is in a power-off state or a power-on state. A power supply of the electronic device provides power to the EC separately. The power-off herein means that some devices of the electronic device (such as the processor, the hard disk, the display, and the chipsets) with high power consumption are powered off, but the EC remains powered on, and therefore can continue to work. The EC may be configured to set a state flag of the electronic device, and may also control shutdown and startup of the electronic device. When the electronic device needs to be locked, the EC modifies the state flag to the first state flag, and controls the electronic device to restart. The first state flag is used to indicate a state that the electronic device needs to be locked and is not locked.

The basic input/output system (BIOS) is the first software loaded when a computer starts up, and stores the most important basic input/output program of the computer, a startup self-test program, and a system self-boot program. A main function of the basic input/output system is to provide underlying and most direct hardware setting and control for the computer. If the electronic device is a computer, the electronic device includes a BIOS. The processor can specifically read the state flag in a BIOS startup phase, and lock the electronic device when determining that the state flag is the first state flag. In one embodiment, if the electronic device is a mobile phone, the BIOS can be replaced by a bootloader. The processor can specifically read the state flag in a bootloader startup phase, and lock the electronic device when determining that the state flag is the first state flag.

In one embodiment, the BIOS startup phase is different from a normal startup in the prior art. In the startup phase, only drivers necessary for a processor, a bridge chip, and a hard disk are run, and no initialization processing is performed on other software or drivers. For example, in the BIOS startup phase, no initialization processing is performed on software (such as chatting software and document processing software) that is set to auto start by a user. In the BIOS startup phase, no initialization processing is performed on drivers such as a sound card driver, a network card driver, and a universal serial bus (USB) driver. The same principles apply to the bootloader startup phase.

Narrow band internet of things (NB-IoT) is an emerging technology in the field of internet of things, and supports low power devices in the wide area network cellular data connection, also known as a low power wide area network. The NB-IoT supports efficient connection of devices with long standby time and high network connection requirements. An NB-IoT circuit is a low power communication circuit in this application. The low power communication circuit in this application may alternatively be one or more of an enhanced machine type communication (eMTC) circuit, a long range radio (LoRa) circuit, a Sigfox circuit, a bluetooth low energy (BLE) circuit, a low power wireless network (low power WIFI) circuit, and a massive machine type communication (mMTC) circuit. In FIG. 2, an example in which the locking control circuit is an NB-IoT circuit is used. When the electronic device fails to communicate with a server through a mobile communications technology and a wireless local area network, the electronic device can communicate with the server through NB-IoT. Specifically, a power supply of the electronic device separately powers the NB-IoT, so that the NB-IoT is capable of running when the electronic device is in a power-off state or a power-on state.

The display is an output device of the electronic device, and is a displaying tool that displays data on a screen and reflects the data to human eyes. The processor can control the display to display data. The display may be configured to display information input by a user, information provided for the user, and various menus of the electronic device.

The memory is one of important components in the electronic device, and is a bridge for communication with the processor. The memory, also known as internal storage, is configured to temporarily store computing data in the processor and exchange data with external storage such as a hard disk. The processor fetches to-be-computed data into the memory for computation as long as the electronic device is running, and the electronic device transfers a result after the computation is complete. The memory may include components such as a memory chip, a circuit board, and an edge connector.

The hard disk is configured to store data for the electronic device, and the hard disk may be a mechanical hard disk, a solid state hard disk, or another type of hard disk. In one embodiment, when determining that the state flag is the first state flag, the processor may specifically lock a main board of the electronic device by using a main board locking password, and lock the hard disk by using a hard disk locking password. The hard disk locking password may be stored in the hard disk. In one embodiment, the hard disk locking password may be stored in a hard disk controller of the hard disk. A manner of locking the hard disk is first controlling the hard disk to power off so that the hard disk exits from a not-locked state; and then controlling the hard disk to power on, and using the hard disk locking password to lock the hard disk. Specifically, once locked, the hard disk can remain in a locked state if powered on or powered off again.

The chipset (chipset), a core component of the main board, is a bridge for the processor to communicate with peripheral devices. It is a collective term for a “south bridge chip” and a “north bridge chip”.

The Wi-Fi circuit and the LTE circuit are configured to communicate with the server. When the electronic device fails to communicate with the server through the Wi-Fi circuit and the LTE circuit, the electronic device can communicate with the server through NB-IoT.

The keyboard and the touch panel are input devices of the electronic device, and a user can input information to the electronic device through the keyboard and the touch panel. For example, the user can input user identity information by using the keyboard or the touch panel to perform authentication on the user identity; and the processor sends the identity information to the server. The identity information is used by the server to authenticate the user identity.

The indicator may be used to indicate information. For example, when receiving new information, the electronic device can make the indicator flash to indicate that new information is received.

The power button is used to start the power supply. The power supply is configured to provide power for the electronic device. Specifically, the power supply of the electronic device separately powers the NB-IoT and the EC. When the electronic device is powered off, the power supply remains supplying power to the NB-IoT and the EC. Therefore, the NB-IoT and the EC are capable of running when the electronic device is in a power-off state or a power-on state. The power supply supplies power to other components in the electronic device according to a normal power supplying manner. For example, when the electronic device is powered off, the power supply cuts off the power to the components other than the NB-IoT and the EC. Therefore, when the electronic device is in a power-off state, the components other than the NB-IoT and the EC cannot run.

The sensor can be a light sensor, a motion sensor, or another type of sensor.

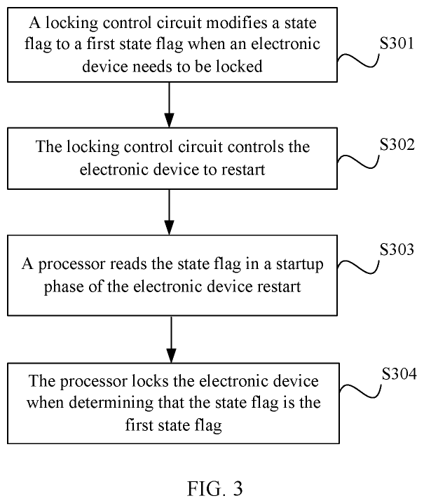

FIG. 3 is a flowchart of a locking method according to an embodiment of this application. The method can be implemented based on the architecture shown in FIG. 1. An electronic device described below may be the electronic device in the system architecture shown in FIG. 1. For the architecture of the electronic device, reference may be made to the architecture shown in FIG. 2. The method includes but is not limited to the following operations.

S301. A locking control circuit modifies a state flag to a first state flag when the electronic device needs to be locked.

The state flag is used to indicate a state of the electronic device, and the state includes whether the electronic device needs to be locked and whether the electronic device has already been locked. Specifically, the state flag may be various data structures. For example, the state flag may be numerical, and specifically, may be a number or a string of numbers, such as 1, 10, or 100. The state flag may also be alphabetical, and specifically, may be a letter or a string of letters, such as Y, AA, or BCD. The state flag may also be symbolic, and specifically, may be a symbol or a sequence of symbols, such as “o”, “□□”, or “Δo”. In one embodiment, the state flag may also contain a server signature that can be used to verify the validity of the state flag. In addition, in this application, the state flag may be one or more data structures used to indicate one or more states. These data structures may be stored in one or more memories, or stored in different portions of one memory. For example, when the state flag needs to represent a plurality of states, they may be represented by using one data structure (for example, using “1” to represent a state that the electronic device needs to be locked and is not locked), or may be represented by a plurality of data structures (for example, using one data structure “2” to represent that the electronic device needs to be locked, and another data structure “b” to represent that the electronic device is not locked).

It should be noted that the state flag may include three possible cases: the first state flag, a second state flag, and a third state flag. These three state flags are flags different from each other in both content and represented meaning. The first state flag is used to indicate a state that the electronic device needs to be locked and is not locked; the second state flag is used to indicate a state that the electronic device needs to be locked and is already locked; and the third state flag is used to indicate a state that the electronic device does not need to be locked.

Table 1 shows a possible case of state flags. The state flag is composed of two digits. The first digit is used to indicate whether the electronic device needs to be locked. When the first digit is 1, it indicates that the electronic device needs to be locked; and when the first digit is 0, it indicates that the electronic device does not need to be locked. The second digit is used to indicate whether the electronic device has already been locked. When the first digit is 0, it indicates that the electronic device has not been locked; and when the first digit is 1, it indicates that the electronic device has been locked.

TABLE 1

| State flag | Content | Represented meaning |
|---|---|---|
| First state flag | 10 | An electronic device needs to be locked, |
| | | and is not locked. |
| Second state flag | 11 | An electronic device needs to be locked, |
| | | and is already locked. |
| Third state flag | 00 | The electronic device does not need to |
| | | be locked. |

Specifically, the state flag is stored in a secure element or the locking control circuit. The secure element may be integrated in the locking control circuit, or may be a standalone apparatus. The locking control circuit can modify the state flag in the secure element.

The locking control circuit is capable of running when the electronic device is in a power-off state or a power-on state. The power supply of the electronic device provides power to the locking control circuit separately. The power-off herein means that some devices of the electronic device (such as the processor, the hard disk, the display, and the chipsets) with high power consumption are powered off, but the locking control circuit remains powered on, and therefore can continue to work. When the electronic device is in a power-on state or a power-off state, the locking control circuit remains powered on. Therefore, the locking control circuit is capable of running when the electronic device is in a power-off state or a power-on state. For example, the locking control circuit may be one or more of an embedded controller (EC), a micro controller (MCU), a digital signal processor, and a power management integrated circuit (PMIC). In this manner, a thief is unable to change a locked state of the electronic device by damaging an operating system of the electronic device, improving security of the electronic device.

The locking control circuit modifies a state flag to a first state flag when the electronic device needs to be locked. There may be a plurality of cases in which the electronic device needs to be locked. The following describes a plurality of cases in which the locking control circuit modifies a state flag to a first state flag when the electronic device needs to be locked.

Case 1: The processor receives a locking instruction from a server through a first application; and the processor notifies, according to the locking instruction, the locking control circuit to modify the state flag to the first state flag.

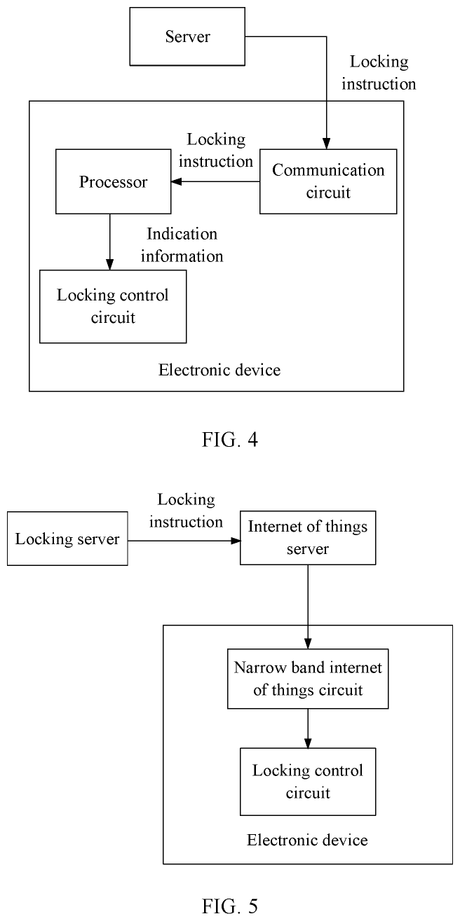

The first application may be an anti-theft management application, such as a computer manager, a security guard, or anti-theft software. FIG. 4 is a schematic diagram of a scenario in which locking is triggered according to an embodiment of this application. An arrow direction in the figure indicates a transmission direction of a locking instruction. If a user wants to lock a lost electronic device, the user can authenticate an identity of the user in the server. After the user identity authentication succeeds, the server sends a locking instruction to the electronic device. If the electronic device is in a power-on and online state, the processor can receive the locking instruction from the server through the first application, and then the processor notifies, according to the locking instruction, the locking control circuit to modify the state flag to the first state flag. The electronic device in an online state means that the electronic device can communicate with the server through a mobile communications technology or a wireless local area network. Specifically, a communication circuit is configured to implement a function of communication with the server through the mobile communications technology or the wireless local area network. A manner in which the processor notifies the locking control circuit may be: sending indication information to the locking control circuit, where the indication information is used to instruct the locking control circuit to modify the state flag to the first state flag; and modifying, by the locking control circuit, the state flag to the first state flag according to the indication information.

Case 2: The electronic device includes a low power communication circuit, and the processor receives a locking instruction from the server through the low power communication circuit; the locking control circuit receives the locking instruction from the server through the low power communication circuit; and the locking control circuit modifies the state flag to the first state flag. The low power communication circuit is one or more of a narrow band interne of things (NB-IoT) circuit, an enhanced machine type communication (eMTC) circuit, a long range radio (LoRa) circuit, a Sigfox circuit, a bluetooth low energy (BLE) circuit, a low power wireless network (low power WIFI) circuit, and a massive machine type communication (mMTC) circuit. When the electronic device fails to communicate with the server through the mobile communications technology and the wireless local area network, the electronic device can communicate with the server through the low power communication circuit. Specifically, the power supply of the electronic device separately powers the low power communication circuit, so that the low power communication circuit is capable of running when the electronic device is in a power-off state or a power-on state. In this manner, when the electronic device is in a power-off state or an offline state, the locking instruction sent from the server can be received through the low power communication circuit, avoiding a problem that the electronic device fails to receive the locking instruction in a power-off state or an offline state. Moreover, with a characteristic of low power consumption, the low power communication circuit does not consume too much power of the electronic device or affect normal use of the electronic device.

FIG. 5 is a schematic diagram of another scenario in which locking is triggered according to an embodiment of this application. An arrow direction in the figure indicates a transmission direction of a locking instruction. Taking that the low power communication circuit is a narrow band Internet of Things circuit for example, the internet of things server can communicate with the narrow band internet of things circuit, and can communicate with a locking server. If a user wants to lock a lost electronic device, the user can authenticate an identity of the user in the locking server (the locking server has the same functions as the server shown in FIG. 1). When the user identity authentication succeeds, the locking server sends a locking instruction to the internet of things server. The internet of things server then sends the locking instruction to the narrow band internet of things circuit, and the narrow band internet of things circuit sends the locking instruction to the locking control circuit. After receiving the locking instruction, the locking control circuit modifies the state flag to the first state flag. In a possible case, the internet of things server and the locking server may be the same server. This is not limited herein.

Case 3: When it is detected that the electronic device is being disassembled, the locking control circuit modifies the state flag to the first state flag.

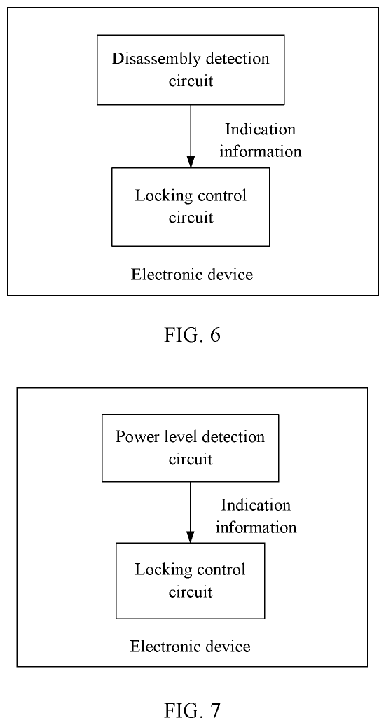

In one embodiment, the electronic device may include a disassembly detection circuit, and the disassembly detection circuit can detect whether the electronic device is being disassembled. FIG. 6 is a schematic diagram of another scenario in which locking is triggered according to an embodiment of this application. When the disassembly detection circuit detects that the electronic device is being disassembled, the disassembly detection circuit sends indication information to the locking control circuit, where the indication information is used to indicate that the electronic device is being disassembled. After the locking control circuit receives the indication information, the locking control circuit modifies the state flag to the first state flag. In one embodiment, the disassembly detection circuit is integrated in the locking control circuit. In this implementation, when the locking control circuit detects that the electronic device is being disassembled, the locking control circuit modifies the state flag to the first state flag. In this manner, the electronic device can be locked when a thief is disassembling the electronic device maliciously, preventing a locking failure due to disassembling of the locking control circuit by the thief, and improving security of the electronic device.

Case 4: When it is detected that a power level of the electronic device falls below a first preset value, the locking control circuit modifies the state flag to the first state flag.

In one embodiment, the electronic device may include a power level detection circuit. FIG. 7 is a schematic diagram of another scenario in which locking is triggered according to an embodiment of this application. The power level detection circuit can detect whether the power level of the electronic device falls below the first preset power level. When the power level detection circuit detects that the power level of the electronic device falls below the first preset power level, the power level detection circuit sends indication information to the locking control circuit, where the indication information is used to indicate that the power level of the electronic device falls below the first preset power level. After the locking control circuit receives the indication information, the locking control circuit modifies the state flag to the first state flag. In one embodiment, the power level detection circuit may be integrated in the locking control circuit. In this implementation, when the locking control circuit detects that the power of the electronic device falls below the first preset power level, the locking control circuit modifies the state flag to the first state flag.

In this manner, a problem can be avoided that the electronic device fails to be restarted and locked after a thief uses up power of the electronic device maliciously, improving security of the electronic device.

Case 5: The electronic device includes a low power communication circuit. The low power communication circuit has the same functions as the low power communication circuit described above, and details are not described herein again. The method further includes: checking, by the low power communication circuit according to a preset cycle, whether the low power communication circuit is normally connected to a server. The preset cycle may be set manually, such as 30 seconds, 1 minute, or 5 minutes. A preset time period may be set manually, such as 1 minute, 3 minutes, 5 minutes, or 10 minutes. The locking control circuit modifies the state flag to the first state flag when it is detected that the electronic device fails to connect to the server within a preset time period through the low power communication circuit. In this manner, a problem can be avoided that the electronic device fails to receive a locking instruction after a thief masks a signal from the low power communication circuit of the electronic device, improving security of the electronic device.

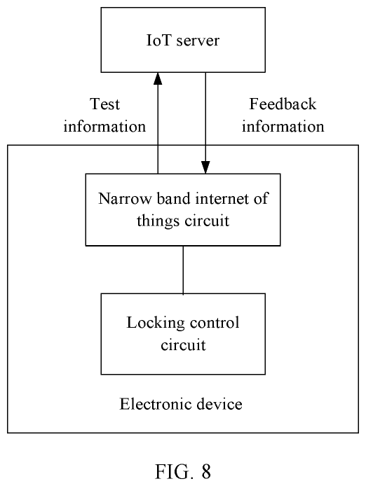

FIG. 8 is a schematic diagram of another scenario in which locking is triggered according to an embodiment of this application. Taking that the low power communication circuit is a narrow band internet of things circuit as an example, the narrow band internet of things circuit sends test information to an internet of things server according to a preset cycle, where the test information is used to detect whether the narrow band internet of things circuit is normally connected to the server. If the test information is received successfully, the internet of things server sends feedback information to the narrow band internet of things circuit. For example, the preset cycle is 1 minute, and the preset time period is 3 minutes. If it is detected that the electronic device receives no feedback information within 3 minutes, it indicates that a quantity of times that the electronic device fails to connect to the server through the low power communication circuit within a preset time period is greater than a second preset value. In this case, the locking control circuit modifies the state flag to the first state flag. In a possible case, the internet of things server and the server shown in FIG. 1 are the same server.

S302. The locking control circuit controls the electronic device to restart.

Specifically, the locking control circuit controls the electronic device to restart, which means the locking control circuit controls the electronic device to power on again. If the electronic device is originally in a power-off state, the locking control circuit controls the electronic device to power on; and if the electronic device originally is in a power-on state, the locking control circuit controls the electronic device to power off and then power on again.

In one embodiment, if the electronic device includes a hard disk, the locking control circuit controls the hard disk to perform an operation of powering off and then powering on again, where the power-off operation makes the hard disk exit from a not-locked state, and the processor locks the hard disk in the power-on process.

S303. The processor reads the state flag in a startup phase of the electronic device restart.

The startup phase is before startup of an operating system of the electronic device. Unlike a normal startup in the prior art, in the startup phase, only drivers necessary for a processor, a bridge chip, and a hard disk are run, and no initialization processing is performed on other software (such as software (chatting software, document processing software, and so on) that is set to auto start by a user) or drivers (such as a sound card driver, a network card driver, and a universal serial bus (USB) driver).

For example, if the electronic device is a computer, the startup phase may be a basic input/output system BIOS startup phase; if the electronic device is a mobile phone, the startup phase may be a bootloader phase. Specifically, a BIOS is the first software loaded when a computer starts up, and stores the most important basic input/output program of the computer, a startup self-test program, and a system self-start program. A main function of the BIOS is to provide underlying and most direct hardware setting and control for the computer. Bootloader is the first segment of code that is run when the mobile phone is powered on, and before a kernel of an operating system runs, can initialize hardware devices and establish memory space mapping. The state flag is read in the above startup phase, so that the reading of the state flag does not depend on the operating system of the electronic device, and a locking failure resulted from a malicious damage of the operating system of the electronic device can be prevented. Moreover, because no software initialization is required in the startup phase, a time for performing locking can be reduced, improving locking efficiency.

In one embodiment, if the state flag is stored in the locking control circuit, the processor reads the state flag in the startup phase of the electronic device restart in the following manner: The processor sends indication information to the locking control circuit, where the indication information is used to instruct the locking control circuit to send the state flag to the processor; the locking control circuit performs security authentication on the processor; and if the security authentication succeeds, the locking control circuit sends the state flag to the processor. In one embodiment, if the security authentication fails, the locking control circuit instructs the processor to lock the electronic device. In this manner, the state flag is stored, read, and modified by the locking control circuit, and security authentication on the processor is added in the reading process, which can prevent the state flag from being parsed or modified maliciously, and improve locking security.

In one embodiment, if the state flag is stored in a secure element, the processor reads the state flag in the startup phase of the electronic device restart in the following manner: The processor sends an access request to the secure element; the secure element performs security authentication on the processor based on the access request; and if the security authentication succeeds, the secure element allows the processor to access the state flag stored in the secure element. Specifically, the state flag in the secure element can be modified only by the locking control circuit, and cannot be modified by the processor, and the state flag in the secure element is not lost in case of power-down. In this manner, the state flag is stored in the secure element. Because the secure element has an encryption/decryption logic circuit in its chip, and data stored by the secure element cannot be modified by the processor, the state flag can be prevented from being maliciously parsed or modified, improving locking security.

S304. The processor locks the electronic device when determining that the state flag is the first state flag.

The first state flag indicates that the electronic device needs to be locked and the electronic device is not locked. In this case, the processor performs a locking operation on the electronic device. Specifically, the electronic device may be locked in various manners. The following describes some possible manners in which the electronic device is locked.

Manner 1: The electronic device generates a locking password; the electronic device uses the locking password to lock the electronic device; and the electronic device sends the locking password to the server. In one embodiment, the electronic device may encrypt the locking password, and then send the encrypted locking password to the server. During unlocking, the server can generate an unlocking credential based on the locking password.

Manner 2: The electronic device sends indication information to a server, where the indication information is used to instruct the server to generate a locking password; and the electronic device receives the locking password from the server, and uses the locking password to lock the electronic device.

Manner 3: The electronic device generates a first locking password; the electronic device sends indication information to a server, where the indication information is used to instruct the server to generate a second locking password; the electronic device receives the second locking password from the server; the electronic device uses the first locking password and the second locking password to lock the electronic device; and the electronic device sends the first locking password to the server.

In this manner, the locking passwords of the electronic device are generated by the electronic device and the server jointly, improving password security.

In one embodiment, the electronic device includes a hard disk, and in the foregoing three locking manners, the locking the electronic device includes: locking a main board of the electronic device, and locking the hard disk. The locking password includes a main board locking password and a hard disk locking password. The main board locking password is used to lock the main board, and the hard disk locking password is used to lock the hard disk, and the hard disk locking password is stored in the hard disk. Specifically, the hard disk locking password may be stored in a hard disk controller of the hard disk. A manner of locking the hard disk is first controlling the hard disk to power off so that the hard disk exits from a not-locked state; and then controlling the hard disk to power on, and using the hard disk locking password to lock the hard disk. Specifically, once locked, the hard disk can remain in a locked state if powered on or powered off again. The locking password may be numerical, alphabetical, a sequence of symbols, or the like.

Specifically, after the locking is complete, the locking control circuit modifies the state flag to a second state flag, where the second state flag is used to indicate a state that the electronic device needs to be locked and is already locked. In one embodiment, after the locking is complete, the locking control circuit controls the electronic device to power off, and sends a locking complete message to the server through the low power communication circuit. The low power communication circuit has the same functions as the low power communication circuit described above. Details are not described herein again. Power of the electronic device can be saved by powering off the electronic device after a successful locking.

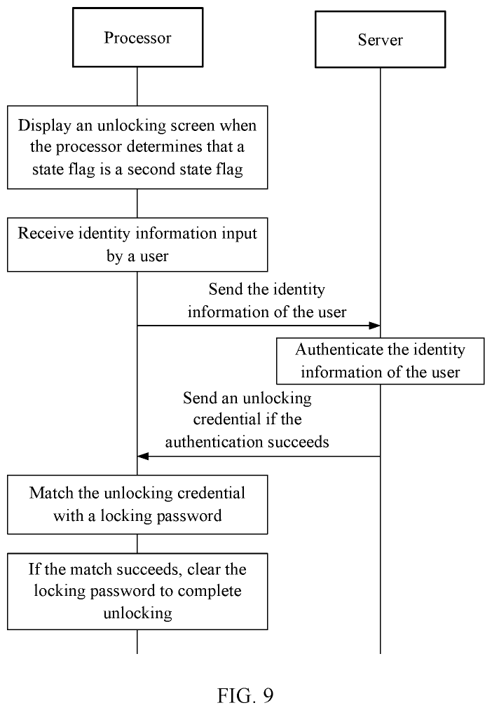

Specifically, after the electronic device is locked, the state flag is modified to the second state flag. The processor determines that the state flag is the second state flag during reading of the state flag in a startup phase of the electronic device restart. When the processor determines that the state flag is the second state flag, the processor pauses the startup and requests user identity authentication. The processor continues the startup after a user identity is authenticated. A manner in which the processor pauses the startup and requests user identity authentication may be: in a startup phase of the electronic device, controlling, by the processor, a display device to display an unlocking screen, where the unlocking screen is used to receive identity information input by the user; and sending, by the processor, the identity information to the server, where the identity information is used by the server to authenticate the user identity. After the user identity is authenticated by the server, the server continues to start the electronic device. FIG. 9 is a flowchart of an unlocking method according to an embodiment of this application.

The following specifically describes an unlocking process. After the user identity is authenticated by the server, the processor can receive an unlocking credential sent from the server, where the unlocking credential is generated based on the locking password after the user identity authentication succeeds; next, the processor matches the unlocking credential with the locking password; and if the match succeeds, the processor clears the locking password to complete unlocking. It should be noted that, after the processor completes the unlocking, the locking control circuit modifies the state flag to a third state flag, where the third state is used to indicate a state that the electronic device does not need to be locked. The processor starts the electronic device normally. That the processor starts the electronic device normally means that the processor normally starts an operating system of the electronic device and all hardware except that already started in the startup phase, and performs initialization processing on software or drivers (such as a sound card driver, a network card driver, and a universal serial bus (USB) driver) that are set to auto start.

A manner in which the processor matches the unlocking credential with the locking password may be: the processor generates an unlocking password in a preset decryption manner based on the unlocking credential; and the processor determines that the unlocking credential matches the locking password if the unlocking password is the same as the locking password, or determines that the unlocking credential does not match the locking password if the unlocking password is different from the locking password.

In one embodiment, the processor includes a hard disk, a manner in which the processor matches the unlocking credential with the locking password may be: the processor generates an unlocking password in a preset decryption manner based on the unlocking credential; the processor sends the unlocking password to a hard disk controller; and the hard disk controller generates a credential based on the unlocking password, and determines that the unlocking credential matches the locking password if the credential is the same as a credential pre-stored by the hard disk controller, or determines that the unlocking credential does not match the locking password if the credential is different from the pre-stored credential.

In the locking method shown in FIG. 3, the locking control circuit modifies the state flag to the first state flag when the electronic device needs to be locked, and then controls the electronic device to restart; and in the startup phase of the electronic device, the processor determines, based on the read first state flag, that the device needs to be locked and is not locked, and then performs a locking operation on the electronic device. Because the locking control circuit is capable of running when the electronic device is in a power-off state or a power-on state, locking of the electronic device does not depend on an operating system of the electronic device, so that the electronic device can be securely locked.

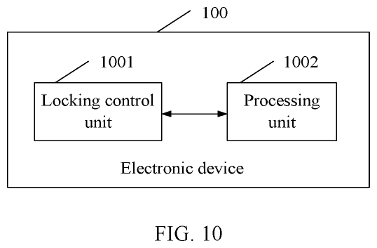

FIG. 10 is a schematic diagram of another electronic device according to an embodiment of this application. The electronic device 100 ncludes a processor 1002 and a locking control circuit 1001. The locking control circuit 1001 is capable of running when the electronic device is in a power-off state or a power-on state. The following provides a specific description of these two components.

The locking control circuit is configured to perform the following operations:

modifying a state flag to a first state flag when the electronic device needs to be locked, where the state flag is used to indicate a state of the electronic device, and the state includes whether the electronic device needs to be locked and whether the electronic device has already been locked; and the first state flag is used to indicate a state that the electronic device needs to be locked and is not locked; and

controlling the electronic device to restart.

The processor is configured to perform the following operations:

reading the state flag in a startup phase of the electronic device restart; and

locking the electronic device when the state flag is the first state flag.

In one embodiment, the state flag is stored in a secure element or the locking control circuit. In this manner, a thief is unable to change a locked state of the electronic device by damaging an operating system of the electronic device, improving security of the electronic device.

In one embodiment, the startup phase is before startup of an operating system of the electronic device. In this manner, a thief is unable to unlock the electronic device by damaging the operating system of the electronic device, improving security of the electronic device.

In one embodiment, if the electronic device is a computer, the startup phase is a basic input/output system BIOS startup phase; and if the electronic device is a mobile phone, the startup phase is a bootloader phase.

In one embodiment, the state flag is stored in the locking control circuit, and the processor is further configured to send indication information to the locking control circuit, where the indication information is used to instruct the locking control circuit to send the state flag to the processor; and the locking control circuit is further configured to: perform security authentication on the processor; and send the state flag to the processor when the security authentication succeeds. In this manner, the state flag is stored, read, and modified by the locking control circuit, and security authentication on the processor is added in the reading process, which can prevent the state flag from being parsed or modified maliciously, and improve locking security.

In one embodiment, the processor is further configured to: receive a locking instruction from a server through a first application; and notify, according to the locking instruction, the locking control circuit to modify the state flag to the first state flag.

In one embodiment, the electronic device includes a low power communication circuit, and the locking control circuit is further configured to: receive a locking instruction from a server through the low power communication circuit; and modify the state flag to the first state flag. In this manner, when the electronic device is in a power-off state or an offline state, the locking instruction sent from the server can be received through the low power communication circuit, avoiding a problem that the electronic device fails to receive the locking instruction in a power-off state or an offline state. Moreover, with a characteristic of low power consumption, the low power communication circuit does not consume too much power of the electronic device or affect normal use of the electronic device.

In one embodiment, the locking control circuit is further configured to: modify the state flag to the first state flag when it is detected that the electronic device is being disassembled. In this manner, the electronic device can be locked when a thief is disassembling the electronic device maliciously, preventing a locking failure due to disassembling of the locking control circuit by the thief, and improving security of the electronic device.

In one embodiment, the locking control circuit is further configured to: modify the state flag to the first state flag when it is detected that a power level of the electronic device falls below a first preset value. In this manner, a problem can be avoided that the electronic device fails to be restarted and locked after a thief uses up power of the electronic device maliciously, improving security of the electronic device.

In one embodiment, the electronic device includes a low power communication circuit. The low power communication circuit is configured to check, according to a preset cycle, whether the low power communication circuit is normally connected to a server; and the locking control circuit is further configured to: modify the state flag to the first state flag when it is detected that the electronic device fails to connect to the server within a preset time period through the low power communication circuit. In this manner, a problem can be avoided that the electronic device fails to receive a locking instruction after a thief masks a signal from the low power communication circuit of the electronic device, improving security of the electronic device.

In one embodiment, the processor is specifically configured to: generate a locking password; use the locking password to lock the electronic device; and send the locking password to the server.

In one embodiment, the processor is specifically configured to: send indication information to the server, where the indication information is used to instruct the server to generate a locking password; and receive the locking password from the server, and use the locking password to lock the electronic device.

In one embodiment, the processor is specifically configured to: generate a first locking password; send indication information to the server, where the indication information is used to instruct the server to generate a second locking password; receive the second locking password from the server; use the first locking password and the second locking password to lock the electronic device; and send the first locking password to the server. In this manner, the locking passwords of the electronic device are generated by the electronic device and the server jointly, improving password security.

In one embodiment, the electronic device includes a hard disk, and the processor is further configured to: lock a main board of the electronic device, and lock the hard disk, where the locking password includes a main board locking password and a hard disk locking password, the main board locking password is used to lock the main board, the hard disk locking password is used to lock the hard disk, and the hard disk locking password is stored in the hard disk.

In one embodiment, the locking control circuit is further configured to: after the locking is complete, modify the state flag to a second state flag, where the second state flag is used to indicate a state that the electronic device needs to be locked and is already locked.

In one embodiment, the processor is further configured to: when it is determined in the startup phase that the state flag is the second state flag, pause the startup and request user identity authentication, and continue the startup after a user identity is authenticated.

In one embodiment, the electronic device includes the low power communication circuit, and the locking control circuit is further configured to: after the locking is complete, control the electronic device to power off, and send a locking complete message to the server through the low power communication circuit.

In one embodiment, the processor is further configured to: receive an unlocking credential sent from the server, where the unlocking credential is generated based on the locking password after the user identity authentication succeeds; match the unlocking credential with the locking password; and if the match succeeds, clear the locking password to complete unlocking.

In one embodiment, the locking control circuit is further configured to: modify the state flag to a third state flag after the electronic device completes the unlocking, where the third state flag is used to indicate a state that the electronic device does not need to be locked; and the processor is further configured to start the electronic device normally.

In one embodiment, the locking control circuit is one or more of an embedded controller EC, a microcontroller MCU, a digital signal processor, and a power management integrated circuit PMIC.

In one embodiment, the low power communication circuit is one or more of a narrow band internet of things NB-IoT circuit, an enhanced machine type communication eMTC circuit, a long range radio LoRa circuit, a Sigfox circuit, a bluetooth low energy BLE circuit, a low power WIFI circuit, and a massive machine type communication mMTC circuit.

In the electronic device, the locking control circuit modifies the state flag to the first state flag when the electronic device needs to be locked, and then controls the electronic device to restart; and in the startup phase of the electronic device, the processor determines, based on the read first state flag, that the device needs to be locked and is not locked, and then performs a locking operation on the electronic device. Because the locking control circuit is capable of running when the electronic device is in a power-off state or a power-on state, locking of the electronic device does not depend on an operating system of the electronic device, so that secure locking can be performed.

In another embodiment of this application, a locking control circuit is provided, where the locking control circuit is configured to perform operations performed by the locking control circuit 1001 in the electronic device shown in FIG. 10.

In another embodiment of this application, a processor is provided, where the processor is configured to perform operations performed by the processor 1002 in the electronic device shown in FIG. 10.

In another embodiment of this application, a computer program product is provided, where when the computer program product is run on a computer, the method according to the embodiment shown in FIG. 3 can be implemented.

In another embodiment of this application, a computer-readable storage medium is provided, where the computer-readable storage medium stores a computer program, and when the computer program is executed by a computer, the method according to the embodiment shown in FIG. 3 is implemented.

The foregoing descriptions are merely specific embodiments of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

1. A locking method of locking an electronic device, comprising:
modifying, by a locking control circuit, a state flag to a first state flag in response to that the electronic device needs to be locked, wherein the electronic device comprises a processor and the locking control circuit, and the locking control circuit is capable of running when the electronic device is in a power-off state or a power-on state, wherein the state flag is to indicate a state of the electronic device, and the state comprises whether the electronic device needs to be locked and whether the electronic device has already been locked, and wherein the first state flag is to indicate a state that the electronic device needs to be locked and is not locked;
controlling, by the locking control circuit, the electronic device to restart;
reading, by the processor, the state flag in a startup phase of an electronic device restart; and
locking, by the processor, the electronic device in response to that the processor determines that the state flag is the first state flag.

2. The method according to claim 1, wherein the startup phase is before a startup of an operating system of the electronic device.

3. The method according to claim 1, wherein the state flag is stored in the locking control circuit, and the reading, by the processor, the state flag in a startup phase of an electronic device restart comprises:
sending, by the processor, indication information to the locking control circuit to instruct the locking control circuit to send the state flag to the processor;
performing, by the locking control circuit, a security authentication on the processor; and
sending, by the locking control circuit, the state flag to the processor in response to that the security authentication succeeds.

4. The method according to claim 1, wherein the modifying, by the locking control circuit, a state flag to a first state flag in response to that the electronic device needs to be locked comprises:
receiving, by the processor, a locking instruction from a server through a first application; and
notifying, by the processor according to the locking instruction, the locking control circuit to modify the state flag to the first state flag.

5. The method according to claim 1, wherein the electronic device comprises a low power communication circuit, and the modifying, by the locking control circuit, a state flag to a first state flag in response to that the electronic device needs to be locked comprises:
receiving, by the locking control circuit, a locking instruction from a server through the low power communication circuit; and
modifying, by the locking control circuit, the state flag to the first state flag.

6. The method according to claim 1, wherein the modifying, by the locking control circuit, a state flag to a first state flag in response to that the electronic device needs to be locked comprises:
modifying, by the locking control circuit, the state flag to the first state flag in response to that it is detected that the electronic device is being disassembled.

7. The method according to claim 1, wherein the electronic device comprises a low power communication circuit, and the method further comprises:
checking, by the low power communication circuit according to a preset cycle, whether the low power communication circuit is connected to a server within a preset time period; wherein
the modifying, by the locking control circuit, a state flag to a first state flag in response to that the electronic device needs to be locked comprises:
modifying, by the locking control circuit, the state flag to the first state flag in response to that it is detected that the electronic device fails to connect to the server within the preset time period through the low power communication circuit.

8. The method according to claim 1, wherein the method further comprises:
after completing the locking the electronic device, modifying, by the locking control circuit, the state flag to a second state flag, wherein the second state flag is to indicate a state that the electronic device needs to be locked and is already locked.

9. The method according to claim 8, wherein the method further comprises:
in response to that the processor determines in the startup phase that the state flag is the second state flag, pausing, by the processor, the startup, requesting authenticating a user identity, and continuing the startup after the user identity is authenticated.

10. The method according to claim 1, wherein the electronic device comprises the low power communication circuit, and the method further comprises:
after completing the locking the electronic device, controlling, by the locking control circuit, the electronic device to power off, and sending a locking complete message to the server through the low power communication circuit.

11. An electronic device, comprising
a processor; and
a locking control circuit capable of running when the electronic device is in a power-off state or a power-on state, the locking control circuit is configured to perform the following operations:
modifying a state flag to a first state flag in response to that the electronic device needs to be locked, wherein the state flag is to indicate a state of the electronic device, and the state comprises whether the electronic device needs to be locked and whether the electronic device has already been locked, and wherein the first state flag is to indicate a state that the electronic device needs to be locked and is not locked; and
controlling the electronic device to restart; and
wherein the processor is configured to perform the following operations:
reading the state flag in a startup phase of an electronic device restart; and
locking the electronic device in response to that the state flag is the first state flag.

12. The electronic device according to claim 11, wherein the startup phase is before a startup of an operating system of the electronic device.

13. The electronic device according to claim 11, wherein the state flag is stored in the locking control circuit, and the processor is further configured to send indication information to the locking control circuit to instruct the locking control circuit to send the state flag to the processor; and
the locking control circuit is further configured to:
perform a security authentication on the processor; and
send the state flag to the processor in response to that the security authentication succeeds.

14. The electronic device according to claim 11, wherein the processor is further configured to:
receive a locking instruction from a server through a first application; and
notify, according to the locking instruction, the locking control circuit to modify the state flag to the first state flag.

15. The electronic device according to claim 11, wherein the electronic device comprises a low power communication circuit, and the locking control circuit is further configured to:
receive a locking instruction from a server through the low power communication circuit; and
modify the state flag to the first state flag.

16. The electronic device according to claim 11, wherein the locking control circuit is further configured to:
modify the state flag to the first state flag in response to that it is detected that the electronic device is being disassembled.

17. The electronic device according to claim 11, wherein the electronic device comprises a low power communication circuit, and the low power communication circuit is configured to check, according to a preset cycle, whether low power communication circuit is connected to a server within a preset time period;
wherein
the locking control circuit is further configured to:
modify the state flag to the first state flag in response to that it is detected that the electronic device fails to connect to the server within the preset time period through the low power communication circuit.

18. The electronic device according to claim 11, wherein the locking control circuit is further configured to:
after completing the locking the electronic device, modify the state flag to a second state flag, wherein the second state flag is to indicate a state that the electronic device needs to be locked and is already locked.

19. The electronic device according to claim 18, wherein the processor is further configured to:
in response to that it is determined in the startup phase that the state flag is the second state flag, pause the startup, request authenticating a user identity, and continue the startup after the user identity is authenticated.

20. The electronic device according to claim 11, wherein the electronic device comprises the low power communication circuit, and the locking control circuit is further configured to:
after completing the locking the electronic device, control the electronic device to power off, and send a locking complete message to the server through the low power communication circuit.
